(19) United States
(12) Patent Application Publication
(10) Pub. No.: US 2011/0242310 A1
(43) Pub. Date: Oct. 6, 2011

(54) Apparatus and Method for Electrospinning Nanofibers

(75) Inventors: Thomas Paul Beebe, JR., Landenberg, PA (US); Bruce Chase, Newark, DE (US); Giriprasath Gururajan, Bartlesville, OK (US); John Rabolt, Greenville, DE (US); Shawn Sullivan, Oakmont, PA (US)

(73) Assignee: University of Delaware, Newark, DE (US)

(21) Appl. No.: 12/986,750

(22) Filed: Jan. 7, 2011

Related U.S. Application Data
(60) Provisional application No. 61/293,055, filed on Jan. 7, 2010.

(51) Int. Cl. G06K 9/00; B27N 3/14; D02G 3/00; H04N 7/18

(52) U.S. Cl. 348/88; 425/174.8 E; 264/484; 428/364; 382/111; 348/E07.085

(57) ABSTRACT

Nanofiber electroprocessing apparatus comprising a conductive stylus having a 5 to 250 nm diameter tip; a collector spaced below the tip; a continuous supply of flowable polymer to the tip, and a power supply for creating a potential difference between the tip and the collector sufficient to produce a nanofiber. The conductive stylus may comprise an atomic force microscope (AFM) tip and may further be mounted within an AFM scanning holder having a mechanism for moving the tip. A method of electroprocessing a nanofiber comprises providing the conductive stylus, such as an AFM tip, providing a collector below the tip, supplying the tip with the flowable polymer, energizing the tip to create a potential difference between the tip and the collector, and thereby producing the nanofiber. Systems and methods for using nanofibers so created may be used for anticounterfeiting or object identification.

### CROSS REFERENCE TO RELATED APPLICATIONS

This application claims priority to U.S. Provisional Application Ser. No. 61/293,055, filed Jan. 7, 2010, which is incorporated herein, in its entirety, by reference.

### STATEMENT REGARDING FEDERALLY SPONSORED RESEARCH

The invention described in this application was supported in part by National Science Foundation Grant No. NSF DMR0704970. The U.S. Government may have certain rights in this invention.

### BACKGROUND OF THE INVENTION

The technique of electrospinning has been around since the 1930s. Originally, electrospinning was used primarily for the production of textiles such as yarn. In today's applications electrospinning is used to produce micro- and nanofibers that can be woven into porous meshes for various applications, including for use as biomaterials. The material properties afforded by these micro- and nanofibrous meshes/scaffolds make them ideally suited for use in areas of wound repair, as surgical grafts, as cell growth promoters, in tissue-engineering, and in dental applications, amongst others. Over that past decade a large body of literature has been generated on electrospinning of polymer fibers.

The technique of electrospinning, as it is conventionally practiced, uses a high potential applied to the needle tip of a syringe containing a polymer solution. This potential provides enough field strength such that a small solution volume forming at the end of the metallic tip can form a Taylor cone, much like an electrospray mass spectrometer. Eventually the electric field generated by the applied potential and the small tip (spinnerette) provides sufficient force to overcome the surface tension of the Taylor cone, and a polymer jet (wet fiber) is formed. By applying a negative potential, or by grounding a collection target located below the needle, the fiber is pulled toward the target by electrostatics. The distance of the target from the spinnerette is referred to as the working distance. Because solvent evaporates as the wet polymer jet fiber travels toward the target, the working distance affects fiber formation. If the working distance is too short for sufficient solvent evaporation, the morphology of the deposited fiber mat may be dominated by solvent drying effects in and on the mat. Humidity also has an effect on fiber formation.

Fiber collection methods have been investigated to provide spatial control and alignment of electrospun fibers. By controlling the rate of fiber uptake, it is possible to create mats of parallel fibers, as opposed to the random “spaghetti-like” fibrous mats. In addition to using take-up mandrels and disks, for example, other methods have also been used to create intricate fiber alignments. It has been suggested to use split electrode pairs and multiple electrodes to align fibers electrostatically. Likewise, it has been suggested to use a collector with a gap that not only aligns the macroscopic fibers, but also aligns the microscopic polymer chains along the fiber axes. It has also been demonstrated that a dual-ring collector can be used to collect aligned fibers, and that yarn may be made by rotating one electrode while holding the other stationary. Such aligned fibers have applications in water and air filtration, as scaffolds for tissue and cell engineering, as nanoelectric devices, and in the textile industry.

In addition to controlling the alignment of the fibers, there has been interest in controlling where on a target the fibers are actually deposited, in one and two dimensions. Control of where a fiber is deposited is useful for applications including patterning and nanodevice fabrication. DC focusing fields and time-varying steering fields may be used for spatial control of electrospun polymer fiber deposition. Reducing spinnerette tip diameter to 25 μm has allowed the spinnerettes to produce nanofibers from 50-500 nm diameter.

There is still a need in the art, however, for miniaturized electrospinning apparatus that permit smaller volumes of polymer solutions needed to spin fibers, lower potentials needed to initiate and sustain the electrospinning, shorter working distances to collect the fibers, reduced characteristic spot size, the potential to spatially control the deposition of fibers, and continuous production of such fibers. Some of these features rely directly on the size of the tip used when electrospinning the fibers. In the conventional apparatus, the tip can range in inner diameter from 0.3 mm-1.5 mm. Reducing the tip size into the nanometer range permits reduction in the volume of polymer solution needed and the magnitude of the potential required to achieve the field strength to overcome the surface tension of the Taylor cone.

### SUMMARY OF THE INVENTION

The various aspects of the invention generally comprise apparatus and methods for electroprocessing nanofibers.

One claimed exemplary embodiment comprises an apparatus for electroprocessing nanofibers with a conductive stylus having a tip with a diameter in a range of 5 to 250 nm, or in some embodiments, in a range of 10 to 50 nm. A collector is spaced below the tip. In the apparatus a flowable polymer is supplied in a continuous stream to the stylus tip. The flowable polymer may be any polymer in any form that is suitable for creating electroprocessed nanofibers. A power supply is connected to the stylus for providing a potential difference between the stylus tip and the collector. The potential difference is sufficient to produce a nanofiber on the collector from the polymer released from the stylus tip.

Depending on the use of the apparatus, the probe tip may be a single walled or multiple walled carbon nanotube. To aid the creation of the electroprocessed nanofibers, a plurality of conductive stylus tips may be arranged in an array capable of spinning a plurality of nanofibers simultaneously. In one embodiment of the present invention, the conductive stylus may be made of gold or other conducting metal.

The conductive stylus tip or tips may be arranged in a two dimensional array above the collector, such as an array of the type in which AFM stylus tips may be commercially purchased on a single wafer or portion thereof. In one embodiment of the present invention, the conductive stylus tip or tips may be moved in an X, Y or Z direction. In this embodiment, the apparatus also has control elements for moving and controlling the location of the stylus tip. These control element maybe piezoelectric control elements or any other elements known in the art.

In another embodiment of the present invention, the conductive stylus may be mounted on a cantilever attached to a holder. The conductive stylus may be an atomic force microscope (hereinafter “AFM”) tip. In yet another embodiment, the atomic force microscope may be mounted within an AFM scanning holder, which includes an AFM scanning mechanism for moving the AFM tip.

Another claimed exemplary embodiment relates to a method of electroprocessing a nanofiber. The method comprises providing a conductive stylus having a tip with a diameter in a range of 5 to 250 nm, or in some embodiments, in a range of 10 to 50 nm and providing a collector below the tip. The method further comprises supplying to the tip a polymer suitable for electroprocessing nanofibers and then energizing the tip with a voltage that creates a potential difference between the tip and the collector. Finally, the method comprises producing the electroprocessed nanofiber.

In one embodiment of the method the step of providing the conductive stylus comprises providing an atomic force microscope (AFM) tip. The method may further include providing a plurality of tips above the collector in an array, supplying polymer to the array of tips, energizing the array of tips, and producing a plurality of nanofibers simultaneously. The method may also include producing a fiber mat from the plurality of nanofibers.

In one embodiment, the method further comprises changing the spatial location of the tip while generating the nanofiber. This changing of the spatial location of the tip may occur in two-dimensional space. Furthermore, the method may include producing a patterned structure by changing the spatial location of the tip while generating the nanofiber.

In yet another embodiment, the invention relates to an electrospun fiber produced by the method described above. This fiber may have a diameter of approximately 100 nanometers.

### BRIEF DESCRIPTION OF THE DRAWINGS

The foregoing summary, as well as the following detailed description of exemplary embodiments of the invention, will be better understood when read in conjunction with the appended drawings, which are incorporated herein and constitute part of this specification. For the purposes of illustrating the invention, there are shown in the drawings exemplary embodiments of the present invention. It should be understood, however, that the invention is not limited to the precise arrangements and instrumentalities shown. In the drawings, the same reference numerals are employed for designating the same elements throughout the several figures. In the drawings:

FIG. 1 is a schematic diagram of an atomic force microscopy probe tip based electrospinning process;

FIG. 2A is a scanning electron micrograph image of 1 wt % Nylon 6 in HFIP electrospun fibers formed with an AFM probe tip, with an inset showing a higher magnification image of the same;

FIG. 2B is a scanning electron micrograph image of 2 wt % Nylon 6 in HFIP electrospun fibers formed with an AFM probe tip, with an inset showing a higher magnification image of the same;

FIG. 2C is a scanning electron micrograph image of aligned Nylon 6 electrospun fibers formed with an AFM probe tip and a 0.5 cm gap-collector, with an inset showing a higher magnification image of the same; and

FIG. 2D is a scanning electron micrograph image of 2 wt % Nylon 6 in HFIP electrospun mat formed from conventional electrospinning, with an inset showing a higher magnification image of the same.

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

A novel approach to electrospinning is herein revealed by miniaturizing the conventional apparatus, utilizing a modified AFM probe to serve as the spinneret with a tip diameter of approximately 10-50 nm, as compared to 1.5 mm for a conventional syringe-based electrospinning setup, resulting in a 10⁵ reduction in spinneret size, and providing a continuous flow of polymer material to the tip. Miniaturizing the electrospinning apparatus enables reduction of the working distance and the lateral dimensions of the electrospun fiber mat diameter to ˜1 cm without using focusing electrodes. Using the subject AFM probe to electrospin creates routinely electrospin fibers with ultra-small diameters (−100 nm) due to the high field strength present, compared to syringe-based electrospinning.

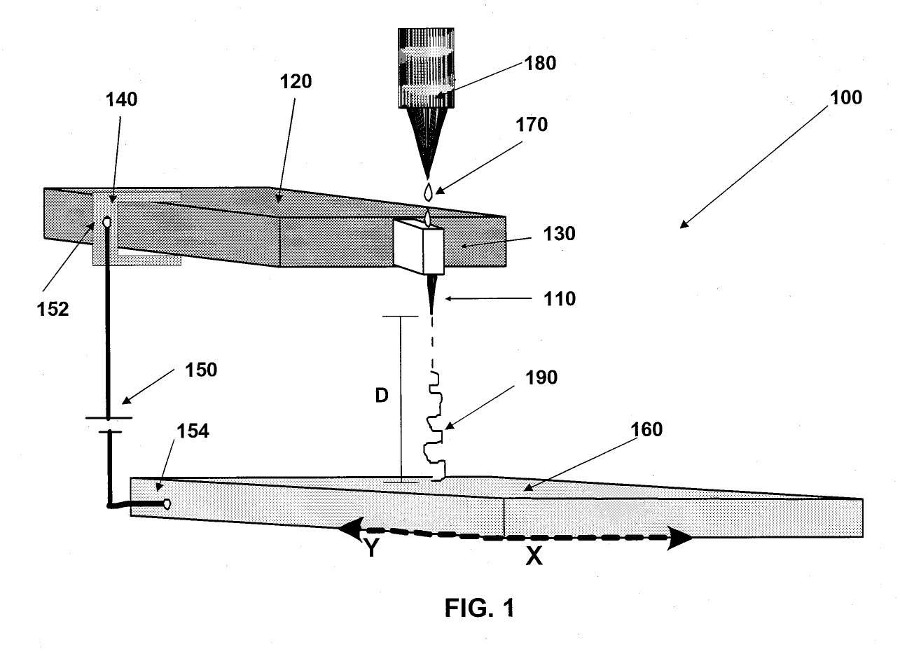

FIG. 1 shows a schematic diagram of an exemplary atomic force microscopy probe tip based electrospinning process as described herein. The exemplary apparatus may be described as generally comprising a conductive stylus 130, having a tip 110 with a diameter in a range of 5 to 250 nm, or in certain embodiments in a range of 10-50 nm; a collector 160 spaced below the tip; a supply of flowable polymer 170 in a continuous stream to the stylus tip; and a power supply 150 connected to the stylus for providing a potential difference between the stylus tip and the collector sufficient to produce a nanofiber on the collector from the flowable polymer released from the stylus tip. The collector 160 may be any suitable surface on which it is desired to deposit or collect the nanofibers, such as but not limited to, aluminum foil, metal plates, mandrels, semiconductor chips, and the like. In some embodiments (not shown), the collector may be movable to permit continuous fiber formation. The probe may comprise, for example, a single walled or multiple walled carbon nanotube. In one embodiment (not shown), a plurality of conductive stylus tips may be arranged in an array capable of spinning a plurality of nanofibers simultaneously, such as an array of AFM tips known in the art and available for commercial purchase, or as described in U.S. Pat. No. 7,775,088, incorporated herein by reference. In one embodiment, such an array may simply comprise multiple apparatus as shown in FIG. 1 arranged side-by-side. The potential difference may be an AC potential or DC potential, without limitation, although a DC potential is generally more commonly used.

The term “flowable polymer” as used herein refers to any polymer having characteristics suitable for flowing from the supply point of the polymer to the stylus tip, such as a polymer solution or a melted polymer. For use with melted polymers, the apparatus may comprise one or more heating elements, such as a directed radiation source, for maintaining the polymer at a suitable temperature to keep the polymer flowable until it has been spun from the electrospinning tip.

In some embodiments, control elements (not shown) may be provided for moving and controlling the location of the stylus tip. Such movement may be in the one, two, or three dimensions, as desired. Exemplary control elements include piezoelectric control elements well known in the art and commercially available for controlling AFM tips, such as but not limited to those described in U.S. Pat. Nos. 5,729,015 and 6,189,374, both of which are incorporated herein by reference for their teachings. For example, the AFM tip may be mounted within an AFM scanning holder known in the art, and one embodiment may comprise an AFM scanning mechanism for moving the AFM tip. The conductive stylus may be metal coated in part or in whole, such as with gold, and may be mounted on a cantilever attached to a holder, such as in an embodiment in which the conductive stylus comprises an AFM tip. Various embodiments are described in greater detail below.

FIG. 1 represents the setup 100 used for electrospinning a material 170, e.g., a polymer, using an AFM tip (such as, but not limited to, AFM tip model number ContGB-10, available from Budget Sensor, USA). As shown in FIG. 1, probe tip 110 is attached to a chip 120 through a cantilever 130. Chip 120 is held in place by chip holder 140. Chip holder 140 comprises a first pole 152 connected to voltage 150. Collector 160 comprises second pole 154 connected to voltage 150. In the embodiment illustrated in FIG. 1, the probe tip is a monolithic symmetric tip of 25 nm size. Polymer droplets 170 are dropped from a microliter pipette 180 onto the cantilever 130. Polymer droplets 170 pool on cantilever 130, and the surface tension of the polymer causes it to wick around the cantilever to probe tip 110. When the desired negative potential is achieved between the collector 160 and the probe tip 110, a polymer jet of wet fiber 190 is formed. The polymer jet of wet fiber 190 falls onto collector 160 to form the fiber mat.

The distance of the target from the spinnerette is referred to as the working distance D. Working distance D may be important during fiber formation because if the working distance is too short for sufficient solvent evaporation, the morphology of the deposited fiber mat may be dominated by solvent drying effects in and on the mat. This effect, along with the effect of humidity, may alter the polymer jet of wet fiber and may adversely affecting the electrospinning process, if not properly controlled. A range of working distances may be suitable for electrospinning, however, depending upon the polymer used, and therefore some embodiments may include not only moving the probe in two dimensions in a plane parallel to the collector, but also movement closer and farther from the collector within the range of suitable working distances.

There are numerous benefits to the apparatus described above. Firstly, the setup described above reduces the diameter of the resulting fiber mats without the need for focusing electrodes. Another advantage is that the apparatus is capable of electrospinning smaller diameter fibers using the same concentration of polymer solution typically used for creation of larger diameter fibers. Yet another advantage is that the fibers that result from the use of the apparatus may be chemically and morphologically the same as those spun with conventional methods, or in some instances may have a lesser degree of crystallinity, which may have certain advantages. This apparatus also allows continuous electrospinning of fiber mats using small volumes of solutions, which is both a safety and environmental benefit (less exposure to solvent fumes), and an economic benefit (ability to electrospin other proteins that would be too expensive to electrospin at mL quantities). Finally, as described below, embodiments of the apparatus may include the ability to preferentially orient or position fibers by using the technology of scanning probe microscopes with precise lateral motion control of piezoelectric ceramics.

In one embodiment, longer cantilevers (>250 μm) may be useful for avoiding contact of polymer droplets on the sharp edges of the chip. In this embodiment, a microliter pipette tip coupled to a Teflon tube is carefully held above the AFM cantilever near the tip end so that the polymer solution may be continuously fed using a syringe pump. In this way, a desired flow rate, for instance a flow rate of 0.2 ml/hr, may be maintained throughout the process. In another embodiment, a pipette may be used to place a drop of polymer solution directly onto the top of the AFM cantilever, and remain in contact, or at least fluid contact or in fluid communication, with the cantilever. The terms “in fluid contact” or “in fluid communication” mean that the surface tension of the flowable polymer is such that polymer in one location is fluidly connected to the polymer in another location. Thus, for example, where the fluid reservoir comprises a pipette, the end of the pipette itself may not physically touch the cantilever, but the fluid in the pipette and the fluid on the cantilever may be connected via a stream of fluid. In some embodiments, however, the end of the pipette may physically touch the cantilever. Similarly, the fluid on top of the cantilever may be said to be in fluid communication with the fluid on the stylus, because of the continuous flow of fluid from the top side to the underside of the cantilever. Thus, the flowable polymer on the top of the cantilever is in fluid communication with the stylus on the bottom of the cantilever by virtue of the surface tension of the flowable polymer that wicks around the cantilever to the stylus tip on the underside of the cantilever. To hold the pipette in a precise position, the apparatus may include a micromanipulator, such as a Model M325 available from World Precision Instruments of Sarasota, Fla.

It should be understood that the continuous supply of polymer is not limited to any particular configuration, and that a supply of polymer via a conduit closed to the atmosphere until a location adjacent the stylus tip on the underside of the cantilever may also be provided. Similarly, a cantilever with a through-hole adjacent the stylus (not shown) may also be fabricated to permit a direct flow of polymer from the polymer supply to the stylus on the underside of the cantilever. Although “pipettes” are referred to herein as exemplary supply conduits, it should be understood that the size of the flowable polymer reservoir is not limited to any particular configuration or structure. Rather, the conduit from the polymer reservoir to a desired location adjacent the stylus must simply be of a size suitable to permit the desired amount of flow from the reservoir to the spinerette.

In certain embodiments, the spinnerette tip size may be ˜10-50 nm, such as using widely available, mass-produced AFM cantilever tips. It should be understood, however, that the invention is not limited to the use of AFM cantilever tips, nor is it limited to any particular size of such tips. Although the 10-50 nm range relates to currently used and widely available AFM tips, AFM tips may have a size generally in the 5-250 nm range. In some embodiments, silicon nitride contact-mode AFM tips with a gold/chromium layer on the back side of the cantilever chip (part #DNP, purchased from Veeco/Digital Instruments, Santa Barbara, Calif.) were used. The invention is not limited to any particular brand or style of AFM cantilever tip, however.

In order to use the tips in an electrospinning device, an additional gold layer may be deposited on the front (tip) side of the cantilever chips to provide sufficient electrical conductivity. In one embodiment, this may be done using a vacuum evaporator. The AFM tips may be mounted on a custom-built sample stage using double-sided carbon tape and loaded into the vacuum evaporator. Gold shot (99.95%) may be loaded into a tungsten wire crucible boat an then resistively heated to the melting point for the deposition. In one embodiment, 30-50 nm of gold was deposited onto the tip side of room-temperature AFM cantilevers at a rate of 0.1 to 0.2 nm s⁻¹, as measured by a quartz crystal microbalance (Inficon—XTC/2). Although gold is an ideal metal coating for providing the desirable conductivity to the AFM tip, the invention is not limited to the use of any particular type of metal, as any metal capable of being readily and controllably deposited on the stylus and capable of providing suitable conductivity for an electrospinning application may be used.

In other instances, in order to use the cantilevers as a spinnerette source after they were modified with gold, a commercially available AFM cantilever holder was used. This holder was designed to be used in conjunction with the Veeco Bioscope AFM (Model #—DAFMLN), which functions as an AFM capable of acquiring optical microscopy images simultaneously, on top of an inverted microscope. Slight modifications to the chip holder may be made in order to apply a high positive potential to the cantilever for electrospinning. For example, the center conductor of a coaxial cable with an SHV connector on the opposite end may be soldered to the clip of the cantilever holder without damaging the circuitry of the holder so the tip holder can still be used for AFM scanning. The Bioscope embodiment permits AFM scanning because the cantilever holder contains a small piezoelectric element used for imaging in an intermittent-contact mode, also called tapping mode, as is well known in the art.

In another embodiment, the apparatus may be used while scanning in the lateral dimension, or (x-y) plane, using the precise control of the piezoelectric elements in the scan head of the AFM, to allow the preferential positioning of fibers in patterns as they are being electrospun, a capability that is not currently possible with a conventional electrospinning setup. Some embodiments may also include movement in the Z direction. Using this AFM approach to electrospinning permits arranging an array of tips operated in parallel to increase the throughput, thereby scaling up the production of polymer nanofibers. Commercialization of the electrospinning process for production of polymer nanofibers has heretofore been hampered by low throughput.

In another embodiment (not shown), an array of tips may be operated in series, or in some combination of in series and in parallel. For example, an array of tips may be supplied with different voltages supplied to each tip (such as in a predefined pattern or randomly) to create nanofibers of different diameters and/or morphology.

Although described herein in relation to commercially available AFM tips, the invention is not limited to the use of AFM tips. In particular, the logic typically provided on the AFM chip is not necessary. Thus, special probe tips may be provided which lack logic circuitry, but which still provide the desirable tip size for carrying out the invention. Similarly, the ability to use a chip capable of fitting in an AFM holder capable of AFM scanning for moving the tip is a commercially convenient way to provide such movement, but the invention is not limited to such a configuration. Any structure capable of providing a tip of suitable diameter in a position where it can receive the feed solution within an electrical field suitable for electrospinning is adequate, and, where movement of the tip is desired, any structure capable of providing movement of the tip on the desired scale may be used.

One use of the invention is to shape materials into nanofibers using the high electric field provided by an atomic force microscopy probe tip and then control the position of the spinnerette (AFM tip) to pattern surfaces with fibers. When the AFM probe tips are used in arrays, many nanofibers can be produced simultaneously, thereby increasing fiber production capacity.

Nanofibers produced by the subject invention may be used for patterning surfaces and/or covering very small areas with fibers, such as during surgery or on a semiconductor integrated circuit. When used in arrays this method can be used to increase throughput.

An exemplary method for electroprocessing a nanofiber comprises the steps of: (a) providing a conductive stylus having a tip with a diameter in a range of 5 to 250 nm, or more preferably in the range of 10 to 50 nm; (b) providing a collector below the tip; (c) supplying to the tip a polymer suitable for electroprocessing nanofibers; (d) energizing the tip with a voltage that creates a potential difference between the tip and the collector; and (e) producing the electroprocessed nanofiber. The step of providing the conductive stylus may comprise providing an AFM tip. The method may further comprise providing a plurality of tips above the collector in an array (not shown), supplying continuous streams of polymer to the array of tips, energizing the array of tips, and producing a plurality of nanofibers simultaneously. Accordingly, the method may include producing a fiber mat from the plurality of nanofibers. In one embodiment, the method may comprise changing the spatial location of the tip while generating the nanofiber, including changing the spatial location of the tip in two-dimensional space, such as producing a patterned structure by changing the spatial location of the tip while generating the nanofiber. Such a patterned nanofiber structure may have any of a number of applications, such as but not limited to use as a security marking for embedding in an object, such as for anti-counterfeiting.

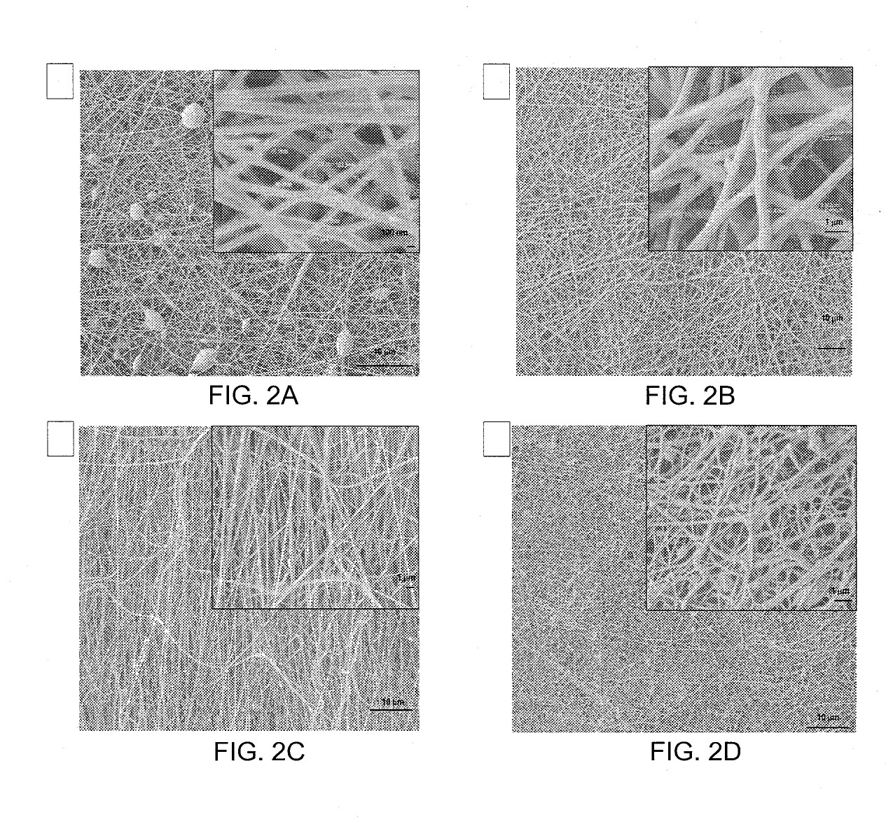

Still another aspect of the invention comprises patterned electrospun fibers, such as those made by the process described above. Objects containing electrospun fibers produced by the processes and methods described herein may be used in an exemplary method for deterring counterfeiting. Such a method comprises the steps of placing an electrospun fiber having a known pattern in a selected location within one or more genuine objects; analyzing an object of unconfirmed origin for presence of the electrospun fiber; and confirming that the object of unconfirmed origin is a genuine object based upon the presence of the electrospun fiber or identifying it as a counterfeit based upon absence of the electrospun fiber. The known pattern may be a intentionally patterned nanofiber produced by changing the spatial location of the tip while generating the nanofiber, as described above, or may be a random pattern produced without an intentional design. An image of the electrospun fiber or portion thereof, such as the images shown in FIGS. 2A-2D, may be saved in a database, and an image of the later detected electrospun fiber in the genuine article may be compared to the retained image for detecting genuineness and/or for providing a unique identifier for confirming the identity of a specific object. A system associated with carrying out such a method further comprises one or more imaging devices of suitable resolution for collecting the originally retained and later detected images of the electrospun fiber, a data storage device, and a processor connected to the data storage device capable of comparing the original and later detected images for confirming the identity of the images, such as a processor running pattern recognition software known in the art. Imaging devices of suitable resolution may include, for example, AFM devices, or optical microscopes with suitable resolution. In one embodiment, the polymer may comprise a fluorescent molecule, such as any molecule known in the art, and the step of detecting the electrospun fiber may comprise applying radiation including wavelengths that cause the molecule to fluoresce, for ease of detection. For example, electrospun fibers may be incorporated into fabrics used for making designer goods, onto tags for affixing to objects, or into paper to be used for printing currency, bonds, or other documents of special value.

A system for identifying objects using unique electrospun fibers may use patterned fibers in which each patterned fiber is intentionally different, such as a pattern shaped to form an alphanumeric code, randomly produced fibers each having a randomly generated image (which can be created, for example, by letting the electrospinning process occur naturally without moving the stylus, or by sending randomly generated instructions, such as by using a computer algorithm for generating such random instructions, to the control mechanism for the stylus to randomly move the stylus), or by using patterned fibers that each, by the nature of the electrospinning process, have their own random imperfections suitably detectable by the image capture devices.

One advantage of the claimed invention is the potential to use significantly lower voltages (for example, 0.01-10 kv) to electrospin nanofibers using the AFM tip, since the working distance can be reduced to the submicron range. Reducing the voltage between the tip and the collector may provide an added benefit for the scale-up production of polymer nanofibers in a commercial environment.

### EXAMPLES

Characterization studies (x-ray, IR, DSC, etc.) have shown that the overall crystallinity of the AFM-electrospun fibers decrease substantially due to the reduction of the working distance and the subsequent “quenching” effect that results. The ability to produce totally amorphous nanofibers of a semicrystalline polymeric material using this AFM-electrospinning, with a significant reduction of the volume of the polymer solutions, the working distance, and the high voltage necessary to electrospin, presents a uniquely new approach to the production of polymer nanofibers.

### Example 1

A first example used silicon nitride contact-mode AFM tips having a spinnerette tip size roughly 10-50 nm, with a gold/chromium layer on the back side of the cantilever chip (part # DNP, purchased from Veeco/Digital Instruments, Santa Barbara, Calif.). To use the tips in an electrospinning device, an additional gold layer was deposited on the front (tip) side of the cantilever chips to provide sufficient electrical conductivity. This was done using a vacuum evaporator (BOC Edwards Auto 306). The AFM tips were mounted on a custom-built sample stage using double-sided carbon tape (Ted Pella, Inc., Reading, Calif.) and loaded into the vacuum evaporator. 99.95% gold shot (Alfa Aesar, Ward Hill, Mass.) was loaded into a tungsten wire crucible boat (R. D. Mathis, Long Beach, Calif.).

The evaporation chamber was then evacuated to a base pressure of 2×10-6 mbar using a liquid-nitrogen-cooled pumping baffle and a turbomolecular pump. The gold shot was resistively heated to the melting point for the deposition. 30-50 nm of gold was deposited onto the tip side of room-temperature AFM cantilevers at a rate of 0.1 to 0.2 nm s⁻¹, as measured by a quartz crystal microbalance (Inficon—XTC/2). The samples were vented to dry nitrogen and used in subsequent experiments.

To hold the cantilevers as a spinnerette source, after they were modified with gold, a commercially available AFM cantilever holder (Model #—DAFMCH, designed by Veeco/Digital Instruments, Santa Barbara, Calif.) was used. This holder is designed to be used in conjunction with the Veeco Bioscope AFM (Model #—DAFMLN), which functions as an AFM capable of acquiring optical microscopy images simultaneously, on top of an inverted microscope. Slight modifications to the chip holder were made to apply a sufficient positive potential to the cantilever to permit electrospinning. The center conductor of a coaxial cable with an SHV connector on the opposite end was soldered with care to the clip of the cantilever holder without damaging the circuitry of the holder, so that the tip holder could still be used for AFM scanning. The cantilever holder contains a small piezoelectric element used for imaging in intermittent-contact mode, also called tapping mode.

Polymer solutions were precisely delivered to the tip of the cantilever using one of two methods. The first method was to use a syringe pump (Aladin AL-1000) with a 5-mL syringe and a 19-gauge needle. A small piece of poly(tetrafluoroethylene) tubing was attached (0.55 mm ID; Alpha Wire Corp., Elizabeth, N.J.) to deliver the polymer solution directly to the back of the cantilever chip. During the stabilization time, the small AFM tips frequently became so saturated with polymer that they were no longer useful as spinnerettes. To overcome this problem a small glass pasteur pipet was used to place a drop of polymer solution directly onto the back of the AFM cantilever chip, and remain in contact. The pipet was held in an exact position using a micromanipulator (Model #—M325, World Precision Instruments, Sarasota, Fla.). This allowed the drop of solution to self-feed along the back of the AFM cantilever chip, down the “steps” of the cantilever chip and out the cantilever legs to the AFM tip. The resulting electric field was high at the extreme end of the tip, thus forming a highly charged Taylor cone and subsequently a polymer jet. The pipette could be used to hold an essentially endless reservoir of spinning solution, and self-feeding of the solution, controlled by solution consumption and wetting of the AFM cantilever. This approach provided a more reproducible jet because it was not necessary to match a very small volume flow rate from a syringe with the consumption rate due to electrospinning.

Polyethylene oxide (PEO, MW 300,000) was purchased from Sigma Aldrich (St. Louis, Mo.) and used as received. A 5% by weight solution was made by dissolving PEO in a 50:50 (v/v) water/ethanol solvent mixture overnight with stirring. A 10% by weight gelatin solution was made by dissolving dry gelatin (Gelatin type IV class-30, Eastman Kodak, Rochester, N.Y.) in a 50:50 (v/v), HFIP/H2O mixture (HFIP is 1,1,1,3,3,3-hexafluoro-2-propanol; Sigma Aldrich, St. Louis, Mo.) overnight with stirring. The water used for all solutions was milliQ™ water with a measured resistivity≧18 MΩ·cm.

All scanning electron microscopy was carried out on a JEOL JSM-7400F field-emission scanning electron microscope (JEOL Ltd. Tokyo, Japan). Prior to image collection, a thin film (≦30 nm) of gold was sputter coated onto the non-conducting polymer mats. This was necessary to reduce sample charging during image acquisition. Typically, a 3.0-keV primary electron beam energy and a LEI detector at varying fields of view was used for image acquisition. The base pressure for the system was 9.6×10⁻⁷ mbar throughout the data collection. Image processing was done initially using JEOL system software, and Adobe Photoshop version 7.0. Image J, a National Institutes of Health (NIH) freeware program was used to determine the fiber diameters on a pixel-by-pixel basis.

XPS analysis was performed on an ESCALab 220i-XL electron spectrometer (VG Scientific, UK) with a monochromatic aluminum K (1486.7 eV) x-ray source. Typical operating conditions for the x-ray source employed a 400-μm diameter nominal x-ray spot size (FWHM) operating at 15 kV, 8.9 mA, and 133 W for both survey and high-resolution spectra. Survey spectra, from 0 to 1200 eV binding energy, were collected at a fixed 100-eV pass energy, resulting in an energy resolution of ˜1.0 eV, a dwell time of 100 ms per point and data spacing of 1 eV⁻¹. High-resolution spectra were collected at a constant pass energy of 20 eV, resulting in an energy resolution of ˜0.2 eV, a dwell time of 100 ms per data point and a data spacing of 0.1 eV⁻¹. For each element present, signal averaging was used to improve the signal-to-noise ratio as needed. A 6-eV electron flood gun source was used to compensate for excess charge build-up, resulting from the non-conducting nature of the polymers. The operating pressure of the spectrometer was typically in the 10⁻⁹ mbar range with a system base pressure of 2×10⁻¹⁰ mbar. Data processing was performed using Computer Aided Spectral Analysis XPS software (CasaXPS, version 2.3.5, UK).

A Magna 860 spectrometer (Nicolet, Inc., Madison, Wis.), equipped with a liquid-nitrogen-cooled mercury-cadmium-telluride (MCT-A) detector was used. The system was allowed to purge under CO₂-free and H₂O-free air for at least 30 min prior to data collection. A background interferogram, consisting of no sample in the beam, was collected immediately prior to experimental spectra. A resolution of 4 cm⁻¹ was used, and 1024 interferograms were collected and averaged, with a data spacing of (1.93 cm⁻¹)⁻¹. Data were both collected and analyzed using Omnic version 5.1 software (Thermo Fisher Scientific, Waltham, Mass.).

Polyethylene oxide was chosen as the initial model system for a comparison of conventional electrospun fibers to those electrospun using a scaled down AFM spinning setup. PEO was chosen due to its availability, its solubility in water-based solvent systems, and its applicability in biomedical applications. The aqueous solubility was advantageous, because electrospinning fibers using the AFM-based electrospinning setup with highly volatile organic solvents was more challenging.

It has been previously discussed that the effective working distance may be reduced by miniaturizing the overall dimensions of the electrospinning setup. To determine the most effective working distance a systematic study was performed of PEO fibers electrospun from the AFM-based setup, in which all parameters were held constant (5 kV positive tip; 5 wt % PEO in 50:50 water/ethanol; spinning solution feed rate) while the working distance was varied from 1-6 cm. PEO fibers were produced at working distances of 3, 4, 5, and 6 cm. No fibers were formed at 1-2 cm working distances. In this particular experimental configuration, producing fibers consistently above 6 cm was challenging because the electrospinning was not continuous, producing resulting fibers that were cracked or broken. The best working distance for producing consistently dry fibers was found to be 4-6 cm for the polymer solution conditions described in this experiment.

One of the goals for the newly developed apparatus was to show that by reducing the spinnerette size, it was possible to reduce the diameter of the resulting deposited polymer spot, by reducing the divergence angle and whipping motion of the polymer jet. Previously this has been accomplished using charged electrodes to confine and limit the whipping action and guide the polymer jet to a specific spot. An experiment was done to create an electrospun PEO fiber mat and a mat electrospun using the new AFM-based setup. The typical diameter of the mat produced using a conventional setup was ˜12 cm at a 6-cm working distance, whereas the spot size created using the AFM-based electrospinning setup measured ˜1 cm at the same 6-cm working distance. This result clearly demonstrates the ability to reduce the polymer jet whipping motion and reduce the diameter of the deposited polymer spot. Thus, the resulting mat diameters were one-sixth and twice, respectively, the working distances for AFM-based and conventional electrospinning setups.

Fiber diameter is a desirable structural feature to compare and control, if possible. Fiber diameter is affected by many electrospinning parameters, including spinnerette tip size. For conventionally electrospun fibers, the average diameter was 124±32 nm (1σ; n=50). For AFM electrospun fibers, the average fiber diameter was 105±40 nm (1σ; n=50). An F-test indicated that the variances of these data sets were different at 95% confidence. Thus a t-test for a comparison of the means with different variances was used. It was determined that the difference of the means of the fiber diameters for each electrospinning method was statistically significant to greater than 99.5% confidence (p=0.005). This result suggests that for PEO the size of the tip affects the fiber diameter, and that the new AFM-based setup is capable of producing PEO fibers that are smaller than those produced by conventional electrospinning, although not dramatically so. Furthermore, this result indicates that the drawing process associated with conventional electrospinning does not play as large a role as previously believed. Since the working distance of the AFM-based electrospun fibers was smaller, and the fiber diameters were also smaller, other factors such as the spinnerette tip size and solution characteristics play significant roles in the resulting fiber diameters. The role of the polymer solution is discussed more below.

To evaluate the chemical composition of the fibers, two spectroscopic techniques were utilized: Fourier transform infrared spectroscopy (FTIR) and X-ray photoelectron spectroscopy (XPS). FTIR provides highly useful molecular structure information, through vibrational frequencies of chemical bonds, whereas XPS provides highly useful elemental and chemical state information for the polymer surface, through photoelectron binding energies. The FTIR results indicate that there were no major or minor chemical changes between the two spinning methods and the bulk cast film.

XPS is a technique that is surface sensitive and provides elemental and chemical information about the upper few monolayers of a sample's surface. For PEO, the spectral regions of interest are the C 1s and O 1s regions. Based on the structure of PEO it was expected to be one major component in both the C 1s and O 1s regions: ether CH₂—O carbon and ether CH₂—O oxygen species. As expected, there was one major carbon component observed at 286.5 eV, which resulted from the ether CH₂—O carbon. A second minor component was observed in all three spectra located at ˜284.8 eV for the cast film and electrospun fibers (conventional and AFM-based), which was determined to be adventitious carbon. The relative amount of adventitious carbon increased from 1.8% to 10.0% to 15.9% in the cast film, the conventional fibers, and the AFM-based fibers, respectively. One major component was observed in the high-resolution O 1s XPS spectra for the cast film, conventional electrospun fiber and AFM-based electrospun fibers, located at 532.0±0.3 eV. Despite the commonly observed adventitious carbon, the surface chemistry observed for carbon and oxygen by XPS were consistent with the structure of PEO.

Electrospun fibers produced using conventional and AFM-based setups were determined to have no significant chemical difference by using FTIR and XPS analyses. Therefore, fibers that are composed of polymers with specific chemical reactivity and functional groups remain virtually the same for AFM-based fibers as for conventionally spun fibers. An additional advantage is the smaller diameter of the PEO fibers produced with the AFM-based setup. A mat consisting of smaller diameter fibers results in a larger surface area per unit mass of the mesh. Such an enhanced surface area could be beneficial for many applications in filtration, wound healing, controlled-release drug delivery, and tissue engineering.

One use of certain embodiments of the claimed invention is for electrospinning from extremely small volumes of expensive and/or highly limited protein and other solutions. Experiments with the protein gelatin were used to demonstrate viability in protein-based systems. Gelatin fibers and control films were analyzed using the previously mentioned techniques (SEM, FTIR, and XPS). For conventionally electrospun fibers, the average diameter was determined to be 698±73 nm (1a; n=70), whereas for AFM-based electrospun gelatin fibers, the average diameter was determined to be 464±109 nm (1a; n=50). An F-test indicated that the variances of these data sets were the same at 95% confidence; therefore, a t-test for a comparison of the means with the same variances was used. It was determined that the difference of the means of the fiber diameters for each electrospinning method was statistically significant at essentially any level of confidence (p=2.5×10-27). As expected from the observations with the PEO system, the diameters of gelatin fibers electrospun from the AFM-based setup were smaller. This result provides additional support for the conclusion that the drawing motion often associated with whipping action in conventional electrospinning does not play a significant role in the resulting fiber diameter. Rather, the spinnerette tip size, the polymer, and the polymer solution characteristics affect the overall diameter most significantly.

Solution characteristics were a significant factor in the AFM-based electrospinning of gelatin. Two polymer solution delivery methods were tested for supplying the polymer solution as it was consumed. When the feed rate was slower than the consumption rate, the polymer solution, which was comprised of volatile organic solvents, became increasingly more viscous as a result of solvent evaporation. The change in polymer solution characteristics led to irregular fiber formation and often saturated the AFM tip until it was no longer useful as a spinnerette. By contrast, allowing a reservoir on the AFM cantilever chip to self-deliver the spinning solution at the required rate greatly improved the stability and reproducibility of the AFM-based electrospinning process.

FTIR analysis was also used to investigate whether the gelatin fibers electrospun using the two methods resulted in significant changes in the chemistry of the gelatin fibers. From the FTIR spectra it was shown that the electrospun fibers were virtually the same for each method, and that when compared to a film, the protein maintained the same spectral features. To the extent that the amide-I and II peaks are indicative of protein secondary structure, the absence of major shifts in the amide-I or amide-II bands indicated that the secondary structure of the protein was similar for the film and the fibers, and that it was most likely helical.

XPS studies of the gelatin fibers provided additional support that the surface chemical compositions of the fibers were the same for either spinning technique. XPS survey spectra showed peaks at 284.6 eV, 531.9 eV, and 400.3 eV for the C 1s, O 1s, and N 1s, respectively. The O 1s and N 1s high-resolution spectra were nearly identical for both spinning method and the thin film, providing additional support that spinning using the AFM-based methods does not alter the surface composition of the electrospun fibers.

FTIR, SEM, and XPS have demonstrated the ability to electrospin protein using small volumes from an AFM cantilever and tip. It has been shown that using the AFM-based setup, and in turn, smaller volumes of protein solution, electrospinning of protein fibers is more cost effective than using a conventional electrospinning setup with its relatively larger amount of waste.

### Example 2

In a second example, Dried Nylon-6 (Sigma-Aldrich, 10000 MW) pellets were dissolved in 1, 1, 1, 3, 3, 3-hexafluoro-2-propanol (HFIP, Sigma Aldrich) over 24 hrs to form 1 wt 2 wt % and 6 wt % polymer solutions. An electric field of 15 KV was applied between the tip and collector separated by a distance of 4 cm. The collector was either a grounded plate or charged gap-collector. An apparatus similar to the AFM based electrospinning apparatus described above and shown in FIG. 1 was used. A gold-coated electrically conductive silicon chip is held using a chip-holder. Prior to the electrospinning process, the chip-holder and the connecting cable of the AFM system were modified in order to apply an electric field to the cantilever. Electrospinning was carried out under ambient conditions at 21° C. and 50% R.H. A flow rate of 0.2 ml/hr was used throughout the electrospinning process.

Though an exact experimental comparison is not feasible, conventional electrospinning was carried out using a typical 22 gauge (390 μm I.D.) needle coupled to a 1 cc syringe, while maintaining a flow rate of 0.2 ml/hr and a potential of 15 KV separated by 4 cm tip-to-collector distance similar to the AFM electrospinning setup. A cast film was also prepared by spin-coating 2 wt % Nylon 6 solution for comparison studies. All samples were stored in a desiccant chamber maintained at ambient temperature and relative humidity.

The collected electrospun fibers were first examined for their morphology using field emission scanning electron microscopy (JEOL JSM-7400F FE-SEM). The crystalline microstructure was investigated using wide-angle X-ray diffraction (WAXD) using a Rigaku D-Max B horizontal diffractometer utilizing 1.54 Å Cu Kα radiation. The 20 scans involved scanning from 5° to 50° with a 0.05° increment. Thermal characterization of the samples was conducted between 50° C. and 250° C. using a Perkin Elmer Diamond differential scanning calorimeter (DSC). A heating and a subsequent cooling cycle involved scanning at the rate of 10° C./min using a sample weight of 2 mg under nitrogen atmosphere. IR spectra were acquired in transmission mode using a Nicolet Nexus 670 FTIR to detect any changes in conformationally sensitive infrared absorption bands of Nylon 6 fibers. The spectral range was from 800 cm⁻¹ to 4000 cm⁻¹ with 128 scans averaged at a spectral resolution of 4 cm⁻¹. For polarized IR measurements, a Thorlabs polarizer was inserted in the beam path to acquire parallel and perpendicular polarized spectra of the aligned samples.

A comparison of collected mats from AFM based and syringe-needle based electrospinning clearly show a difference in the spot-size of the collected fibers from the two techniques. The diameter of the spot was about 1 cm for an AFM electrospun mat, while the spot-size of a conventionally electrospun mat was about ten times larger. The difference may be attributed to the strong localized electric field (E) being concentrated around the curvature of the nanometer size AFM tip compared to a conventional syringe-needle.

A comparison of the γ-component (axial) electric field near the tip for two different tip sizes (400 μm and 2 μm) in a tip-collector system indicate that for the same applied voltage (15000 V) and tip-collector gap (4 cm), the 2 μm tip shows an electric field four times higher (V/m) compared to the 400 μm tip. The field strength is expected to be higher in the case of AFM based electrospinning because the tip size of an AFM probe is about 25 nm, which is about 16,000 times smaller than a typical needle diameter (390 μm) used for electrospinning. This high point charge on the AFM tip induces a very high electric field in the vicinity of the tip, which pulls the liquid jet closer to the collector and results in faster deformation of the fibers within a smaller region. Thus, the spot-size in AFM based electrospinning can be precisely controlled without the use of any focusing electrostatic field as has been utilized in previous studies.

Scanning electron microscopy images were obtained in order to observe the morphology of the collected fibers. FIGS. 2a and 2b show the microscopic images of isotropic mats of 1 wt % and 2 wt % Nylon-6 in HFIP, respectively, formed using an AFM probe tip. The aligned fibers formed using a gap-collector with 2 wt % Nylon-6 solution is presented in FIG. 2c. The fiber diameters are larger than the diameter of the AFM probe tip because the polymer droplets wetting the tip were larger than the AFM tip diameter. Although 1 wt % Nylon 6 solution resulted in the successful formation of dry fibers about 80 nm in diameter (FIG. 2a), there was also intermittent bead formation, likely due to low chain entanglement in this solution. However, uniform diameter fibers (370 nm) without beads were formed using a 2 wt % Nylon-6 solution. Therefore, it was determined that 2 wt % Nylon 6 solution was suitable for electrospinning using an AFM probe tip. Higher concentrations above 6 wt % polymer had problems of flow to the cantilever due to higher viscosity or saturation of the AFM tip within the short duration of the experiment.

FIG. 2d presents the morphology of fibers produced using conventional syringe-needle based electrospinning processed under similar conditions as used in the AFM tip based electrospinning. Significant bead formation and non-uniform fibers can be seen using 2 wt % Nylon 6 in the case of conventional electronspun fibers compared to fibers formed using an AFM tip (FIG. 2b). In addition, higher magnification images show that the fibers appear more fused in conventional electrospun mat compared to the AFM electrospun mat indicating that the solvent evaporation kinetics was different in these two cases. The wide range of diameter distribution of nanofibers noticed in conventional electrospinning is more likely due to unstable jet and whipping instability which causes variations in path length and jet velocity during the process.

A microstructural investigation of the collected fibers from the AFM electrospinning was then conducted. The polymorphic structure of Nylon 6 has been well studied over the years. The most common and stable crystal form of Nylon 6 is the monoclinic (a) form, in which the molecular chains are arranged in an anti-parallel arrangement with an extended planar zig-zag conformation. The α crystalline form is known to be present in slowly crystallized samples or drawn fibers. Another form of monoclinic crystal with a hexagonal/pseudohexagonal packing is the γ form, which has molecular chains arranged in a parallel mode with a twisted (60°) short-chain conformation. The γ form is a metastable structure predominantly produced (along with a small amount of a crystals) during high speed melt spinning or electrospinning processes due to high stress and rapid quenching with insufficient time for the chains to register in an anti-parallel arrangement. The perfection and content of the two types of crystalline structures also varies depending on the processing conditions. The occurrence of metastable γ crystals during electrospinning of nylon 6 with HFIP has been reported by previous researchers.

The microstructure of the collected nylon-6 electrospun mats was first characterized using wide-angle X-ray diffraction. The profiles were normalized to the total area under the scattering curve to account for variation in sample thickness and beam intensity. Both conventional and AFM based electrospun fibers showed predominantly the gamma (γ) crystalline form with diffraction peaks corresponding to 10.9° and 21.5°, respectively in 20 scans. On the other hand, the spin cast film displayed strong peaks at 20.1° and 23.5° characteristic of the thermodynamically favorable a form with crystalline planes. This was due to the differences in crystallization kinetics and solvent evaporation for the two processes that affect the intermolecular hydrogen bonding interactions between chains and inhibit the formation of a planar zig-zag conformation and larger crystallites. As also noted from the WAXD profiles of an AFM electrospun mat and a conventional electrospun mat, the intensities of the 10.9° peak were not different but smaller intensity differences were noted at other peaks.

The quantitative comparison of X-ray profiles from fibers produced with AFM based electrospinning and conventional electrospinning revealed interesting features of the microstructure. As expected, the apparent crystallite size calculated based on the full-width at half maximum (FWHM) using Scherrer's equation (Lₕₖₗ=0.94λ/(β cos θ)) of the (200) peak for the spin cast film was 6.5 nm indicating the formation of large aggregates of γ crystals. On the other hand, the calculated crystallite size based on the full-width at half maximum of the (200) peak for the γ form was 3.6 nm for the case of AFM electronspun mats and 5.1 nm for the case of conventional electrospun mats. This indicated that the crystalline transformation led to smaller size crystals, likely due to insufficient time in the process of crystal growth for AFM-based electrospinning versus syringe-based electrospinning.

In addition, the crystallinity values of the electrospun mats were estimated from the WAXD profiles based on the Gaussian-Lorentzian curve fitting procedure reported in the literature. It has been reported that if there is single crystal structure present in the WAXD profile, the uncertainties in curve fitting are small. As estimated, the crystallinity value of collected samples from AFM and conventional electrospinning was 21±1 wt % and 25±0.5 wt %, respectively. The comparison of γ crystalline content from the two electrospinning processes confirmed the fact that there is suppression of crystallization during the process in addition to formation of smaller crystallites. The kinetics of the solvent evaporation rate was faster than the crystallization kinetics, leading to a large mesomorphic γ region with an increase in amorphous portion due to arrested chain mobility. Thus, X-ray data for the AFM electrospun mat indicated a higher amorphous content with metastable γ form crystals. A similar trend was also observed for 6 wt % Nylon 6 in HFIP.

In order to assess the microstructural differences in terms of molecular signatures, Fourier transform infrared spectroscopy was carried out. The spectral region of interest was between 900 cm⁻¹ and 1300 cm⁻¹. Band assignments are known in the art and can be found in published literature. Several bands had contributions from both α and γ crystalline structure, so only unique bands representing these two forms were used to qualitatively distinguish their contents. The bands at 930 cm⁻¹, 959 cm⁻¹, and 1200 cm⁻¹ have been reported to originate from α-crystals, while the bands at 977 cm⁻¹ and 1214 cm⁻¹ have been attributed to the γ form. The bands were normalized with respect to a methylene twisting or wagging reference band at 1170 cm⁻¹.

In the 920-1020 cm⁻¹ region the AFM electrospun mat clearly showed a significantly higher absorbance value at 977 cm⁻¹ indicating a higher proportion of mesomorphic γ phase compared to conventional electrospun mat and spin cast film. The shoulder at 959 cm⁻¹ (CONH in-plane vibration) is very intense for the spin cast film with high α-crystal content. The same band is also much more apparent for the conventional electrospun mat compared to an AFM tip electrospun mat. Higher a content in the case of the conventional electrospun mat was also confirmed by a higher absorbance band at 1203 cm⁻¹. Though WAXD profiles do not distinguish small amounts of a crystals in the predominantly γ crystallized electrospun mats, FTIR spectral data confirms that there is a significantly higher a crystalline content in conventional electrospun fibers compared to an AFM electrospun mat. The presence of a higher content of stable a form indicates a lower level of stress and slower evaporation kinetics leading to relatively slower crystallization during the conventional electrospinning process compared to AFM electrospinning. This is also supported by the morphology of the fibers shown in the SEM micrographs in FIG. 2d. Therefore, it is more likely the presence of wet fibers causes a significant portion of amorphous phase or metastable γ form to be converted into the stable a form in the case of conventional electrospun mats compared to AFM based electrospun fibers. In the case of an AFM based process, however, the high stress and rapid solvent evaporation is assisted by higher electric field strength on the polymer drops near the tip. This is also supported by the SEM images in FIG. 2b showing dry fibers with a non-beaded morphology.

In order to support the findings from WAXD and infrared spectroscopy, thermal characterization of the samples was carried out. In contrast to X-ray diffraction results, the predominance of a crystalline peak is expected above 180° C., since there is significant melting and reorganization of the chains that can occur during the slow heating scans of the DSC during the first heating cycle. The melting points of AFM electrospun mats and syringe-needle electrospun mats were about 218.5° C. and 219.6° C., respectively. The melting point of a spin cast film was significantly higher at 221° C. indicating an increase in crystallite perfection and crystallite size. From the endotherms, one can also note significant differences in the height of the melting peaks of the γ form indicating higher enthalpy values in the case of syringe-needle electrospinning compared to AFM based electrospinning. The AFM electrospun mats also displayed a small exotherm around 187° C. Previous studies on 8 wt % nylon 6 in HFIP spun at 25 kV found a similar feature in an electrospun sample. It has previously been attributed the exotherm to surface tension release caused by rapid solvent evaporation during the process. From the WAXD and FTIR data, the exotherm could arise from a combination of surface tension release, recrystallization of metastable γ form into stable a form or crystallization of some of the amorphous portion into a form. The crystallinity values estimated based on the standard heat of fusion value of 239 J/g 29 for fully crystalline γ form were 19.8±3.3 wt % for AFM electrospun mats and 26.4±1.4 wt % for conventional electrospun mats. The crystallinity estimated for spin cast film based on the heat of fusion value of 241 J/g 29 for fully crystalline a form was 25.8±1.2 wt %. Thus, DSC results on electrospun mats corroborate the results from X-ray diffraction and FTIR with crystallinity significantly lower for the case of AFM electrospun mats due to high stress and rapid evaporation kinetics, induced by the higher electric field strength.

Thus far the discussion has focused on electrospun mats randomly collected over a small spot size. Several applications, such as photonic devices and electronic sensors require macroscopically or molecularly aligned nanofibers. In order to achieve alignment of fibers, a charged collector gap arrangement was used. For this experiment, a small gap of 0.5 cm was used. The potential difference was maintained at 15 KV with +10 KV to the AFM tip and −5 KV to the gap-collector.

The parallel and perpendicular polarized FTIR spectra of the collected fibers from 2 wt % Nylon 6 solution were determined. Spectra were normalized with respect to a reference band at 1170 cm⁻¹. The changes in vibrational bands in both directions with respect to molecular orientation of the chains have been reported in detail in previous studies. First, the amide I and amide II bands at 1644 cm⁻¹ and 1544 cm⁻¹ respectively, were observed in the spectra. In comparison to the perpendicular polarized spectrum, the amide II band was more intense in parallel polarization because the NH bending vibration is reported to be inline with the electric field vector in the parallel polarization, while the amide I band is weak in the parallel polarized spectrum because the C═O stretching lies perpendicular to fiber axis. The vibrational bands of the two crystalline forms at 930 cm-1 (α) and 977 cm-1 (γ) were also observed in the two polarization directions. The absorbance of the CONH in-plane vibration at 930 cm-1 was observed to be higher in the parallel polarized spectrum compared to the perpendicularly polarized spectrum, while the 977 cm-1 band was observed to be higher in perpendicular polarization direction because the amide group lies out of the plane (60°) in γ form. Thus 2 wt % Nylon 6 electrospun fibers revealed molecular chain anisotropy with a small gap collector.

In summary, electrospinning using an AFM probe tip with a continuous supply of flowable polymer offers a novel and improved methodology in the area of nanodevice fabrication for developing highly ordered nanostructures for electronics and sensor applications. This method allows one to continuously electrospin small amounts of a polymer without issues of clogging. In this study, the experiments were performed in a static setup; however this technique may be also be performed in an arrangement involving a translating XY substrate (not shown) for continuous fabrication of devices. Means for moving the substrate may comprise a roll feeder, a conveyor, or any other suitable device, without limitation. Electrospun fibers from both techniques display predominantly crystalline form; however wide-angle X-ray diffraction (WAXD) and differential scanning calorimetry (DSC) results show a small but significant decrease in crystallinity and crystallite size in AFM spun fibers demonstrating the effect of process dynamics on crystallization and solvent evaporation.

As discussed above, low concentrations of Nylon 6 in HFIP were successfully electrospun into nanofibers onto a small spot (≈1 cm) without the use of focusing electrodes using an atomic force microscope probe-tip as an electrospinning source. Continuous electrospinning using a small AFM tip as a charged source was also demonstrated. Morphological and microstructural investigation of the AFM electrospun mat indicated that uniform dry nanofibers with predominantly metastable γ crystalline structure were formed during the process. WAXD, FTIR and DSC results of the electrospun fibers showed significant microstructural differences between AFM tip based electrospinning and needle based electrospinning. The differences may be attributed to a higher electric field around the AFM tip that leads to rapid solvent evaporation and suppression of the crystallization during the process. Significant molecular anisotropy was observed for 2 wt % Nylon 6 electrospun using an AFM probe tip and collected on a charged-gap collector.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

What is claimed:

1. Apparatus for electroprocessing nanofibers comprising:
a conductive stylus having a tip with a diameter in a range of 10 to 50 nm;
a collector spaced below the tip;
a supply of flowable polymer in a continuous stream to the stylus tip; and
a power supply connected to the stylus for providing a potential difference between the stylus tip and the collector sufficient to produce a nanofiber on the collector from flowable polymer released from the stylus tip.

2. The apparatus of claim 1, wherein the probe tip comprises a single walled or multiple walled carbon nanotube.

3. The apparatus of claim 1 comprising a plurality of conductive stylus tips arranged in an array capable of spinning a plurality of nanofibers simultaneously.

4. The apparatus of claim 1, further comprising control elements for moving and controlling the location of the stylus tip.

5. The apparatus of claim 1, wherein the conductive stylus is mounted on a cantilever attached to a holder.

6. The apparatus of claim 5, wherein the conductive stylus comprises an atomic force microscope tip.

7. The apparatus of claim 6, wherein the atomic force microscope tip is mounted within an atomic force microscope scanning holder, further comprising an atomic force microscope scanning mechanism for moving the atomic force microscope tip.

8. The apparatus of claim 1, wherein the supply of flowable polymer comprises a reservoir of flowable polymer in fluid communication with the conductive stylus.

9. The apparatus of claim 5, wherein the supply of flowable polymer comprises a reservoir of polymer solution in fluid communication with the top surface of the cantilever and fluid on the top side of the cantilever is in fluid communication with the conductive stylus located on an underside of the cantilever.

10. The apparatus of claim 9, further comprising a fluid conduit positioned above the cantilever for feeding flowable polymer.

11. The apparatus of claim 10, further comprising a pump for feeding the flowable polymer to the fluid conduit.

12. The apparatus of claim 9, wherein the reservoir comprises a fluid conduit in fluid contact or physical contact with the cantilever.

13. The apparatus of claim 12, further comprising a micromanipulator for positioning the fluid conduit in physical contact or in fluid contact with the cantilever.

14. A method of electroprocessing a nanofiber, the method comprising:
(a) providing a conductive stylus having a tip with a diameter in a range of 5 to 250 nm;
(b) providing a collector below the tip;
(c) supplying a continuous stream of flowable polymer to the tip;
(d) energizing the tip with a voltage that creates a potential difference between the tip and the collector; and
(e) producing the electroprocessed nanofiber.

15. The method of claim 14, wherein the step of providing the conductive stylus comprises providing an atomic force microscope tip.

16. The method of claim 14 comprising producing a fiber mat from the plurality of nanofibers.

17. The method of claim 14, further comprising changing the spatial location of the tip while generating the nanofiber.

18. The method of claim 14 comprising producing a patterned structure by changing the spatial location of the tip while generating the nanofiber.

19. An electrospun fiber produced by the process of claim 14.

20. An object containing an electrospun fiber of claim 19.

21. A method of marking an object, the method comprising the steps of:
(a) placing an electrospun fiber produced by the process of claim 14 in a selected location within one or more genuine objects;
(b) analyzing an object of unconfirmed origin for presence of the electrospun fiber;
(c) identifying the object of unconfirmed origin to be genuine based upon the presence of the electrospun fiber or counterfeit based upon an absence of the electrospun fiber.

22. The method of claim 21, wherein the electrospun fiber comprises a patterned electrospun fiber.

23. The method of claim 21, wherein the method further comprises collecting and retaining an image of the electrospun fiber, linking the image of the electrospun fiber with identifying information regarding the object in which the electrospun fiber is placed, matching the electrospun fiber detected in step (b) to the image previously collected and retained, and confirming the identity of the object of unconfirmed origin based upon matching the detected fiber to the image of the fiber.

24. A system for identifying an object, the system comprising:
the apparatus of claim 1;
means for capturing and retaining a first image of one or more electrospun fibers produced by the apparatus of claim 1 in conjunction with information identifying an object to be associated with the one or more electrospun fibers;
means for capturing a second image of one or more electrospun fibers in the object;
means for accessing the first image, matching the second image to the first image, and to accessing the information identifying the object.
